(19) United States
(12) Patent Application Publication
(10) Pub. No.: US 2004/0264594 A1
(43) Pub. Date: Dec. 30, 2004

(54) Cancel circuit for high frequency band local leak, radar, and digital radio communication apparatus

(75) Inventors: Masahiro Kasai, Hokkaido (JP); Etsuo Kakishita, Hyogo (JP)

Correspondence Address: OLIFF & BERRIDGE, PLC, P.O. BOX 19928, ALEXANDRIA, VA, 22320, US

(73) Assignees: FUJITSU TEN LIMITED, Kobe-shi (JP); FUJITSU LIMITED, Kawasaki-shi (JP)

(21) Appl. No.: 10/875,715

(22) Filed: Jun. 25, 2004

(30) Foreign Application Priority Data
Jun. 25, 2003 (JP) 2003-181478

(51) Int. Cl. H04L 25/49

(52) U.S. Cl. 375/296

(57) ABSTRACT

To remove a component of a carrier signal contained in a high frequency transmission signal, a distributor divides an original carrier signal output from a carrier oscillator into a signal for modulation and a signal for canceling the carrier signal component after the modulation. A first multiplier multiplies the original carrier signal for modulation. The original carrier signal for canceling is subjected to phase shift in a phase shifter. The phase shifter executes the phase shift of lower frequency than the carrier signal, so that the phase shift can be easily executed in a large shift amount. A level adjustor adjusts a level of the original carrier signal phase-shifted by the phase shifter. A combiner combines the modulated signal with the original carrier signal phase-shifted.

### BACKGROUND OF THE INVENTION

1. Field of the Invention

This invention relates to a cancel circuit for high frequency band local leak for suppressing transmission of a high frequency signal component before being modulated in a high frequency band such as microwaves, millimeter waves, etc., in a radar or a digital radio communication apparatus, and relates to a radar and a digital radio communication apparatus.

2. Description of the Related Art

Hitherto, a high frequency transmission apparatus adopting PSK (Phase Shift Keying) modulation having a configuration as shown in FIG. 7 has been used for communications, radar, etc. That is, a carrier signal of high frequency fo such as a microwave or a millimeter wave is generated in a carrier oscillator 1 and is input to a multiplier 3 together with a data signal generated in a data generator 2. In the multiplier 3, the carrier wave is subjected to PSK modulation with data. PSK modulation output with using a frequency fo as a reference is transmitted from an antenna 4, as schematically shown in FIG. 7A. In the theoretical operation of the multiplier 3 for executing PSK modulation, the carrier signal generated in the carrier oscillator 1 can be excluded from the PSK modulation output. In fact, however, the carrier signal is contained in the PSK modulation output, as shown in FIG. 7B. Such a phenomenon is called local leak, causing SN degradation in a reception unit, saturation of a low-noise high frequency amplifier, etc., because the output level is higher than any other PSK modulation output. Particularly, the effect of the local leak grows in a machine having a transmission unit and a reception unit in one piece.

FIG. 7C shows frequency spectrum of a wide-band modulation called spread spectrum (SS). The SS system has a feature that the modulation signal has a low level. If local leak exists, other communications, etc., are hindered and therefore existence of local leak should be avoided. If mandatory control is applied to the SS system, it is forecasted that the local leak will violate the law.

FIGS. 8A to 8C show representative countermeasures against the local leak in a related art. (For example, refer to JP-A-Sho.58-88907) A BEF (Band Elimination Filter) 5 is inserted between the multiplier 3 and the antenna 4 in FIG. 7A for cutting the carrier signal component of the frequency fo so as to exclude the carrier signal component from the PSK modulation output, as schematically shown in FIG. 8A. FIG. 8B shows the attenuation characteristic of the BEF 5. The BEF 5 also attenuates the nearby frequency bands centering around the frequency fo. If the BEF 5 has high Q (sharpness), the band becomes narrow, but the attenuation amount increases. Consequently, as the PSK modulation output, the bands in the proximity of the frequency fo also attenuate, as shown in FIG. 8C.

FIG. 9 shows the characteristic of a signal provided by demodulating the PSK modulation output with the attenuated component in the proximity of the frequency fo of the carrier signal as shown in FIG. 8C. FIG. 9A shows the frequency spectrum and indicates that the component in the vicinity of direct current (DC) component is lost. FIG. 9B shows an example of a base band signal; loss occurs in such a portion where the same logical level continues. To narrow the attenuated frequency band, Q of the BEF 5 needs to be made high, but it is difficult to manufacture a filter having high Q and the cost is also increased.

JP-A-Sho.58-88907 modifies a related art of using a BEF for an output of a transmission mixer for generating a microwave transmission signal according to a heterodyne technique. JP-A-sho.58-88907 discloses a configuration wherein output of a local oscillator is added to output of a mixer through a compensation circuit for compensating for the phase and amplitude to cancel the local oscillation frequency component. Also JP-A-Hei.8-204772 proposes a configuration wherein the leak component of a carrier signal from a local oscillation unit is combined with a component phase-shifted by 180 degrees by a phase shifter to cancel the leak component in an orthogonal modulation circuit for directly modulating a carrier signal.

### SUMMARY OF THE INVENTION

JP-A-Hei.8-204772 suggests the idea of canceling output of the local oscillation unit by output of opposite phase (180 degrees) to cancel local leak. To use canceling the local leak by output of opposite phase in such a manner, it is made possible to remove only the component of the frequency fo, and removal of the components in the proximity of the frequency fo as well as the component of the frequency fo as caused in the BEF can be avoided. However, it is difficult to develop and integrate a device for performing large phase shifting as 180 degrees in a high frequency band of several 10 GHz.

The invention provides a cancel circuit for high frequency band local leak that can easily increases a phase shift amount to cancel local leak, and provides a radar and a digital radio communication apparatus.

According to one embodiment of the invention, a cancel circuit for local leak includes an oscillation unit, a first multiplier, a modulation unit, a phase shift unit, a second multiplier, and an output unit. The oscillation unit generates an original carrier signal, which has one-over-a-predetermined-integer of a frequency of a carrier signal. The first multiplier multiplies a frequency of the original carrier signal generated by the oscillation unit by the integer to generate the carrier signal. The modulation unit modulates the carrier signal output from the first multiplier to generate a transmission signal having a lower level than the carrier signal. The phase shift unit shifts a phase of the original transmission signal generated by the oscillation unit. The second multiplier multiplies a frequency of the original carrier signal, which is subject to the phase shift by the phase shift unit, by the integer to generate a cancel signal. The output unit combines the transmission signal generated by the modulation unit with the cancel signal generated by the second multiplier to generate and output a combined signal.

In order to prevent leakage of a signal from the oscillation unit when modulating and transmitting the carrier signal in a high frequency band based on the original carrier signal from the local oscillation unit, the cancel circuit for high frequency band local leak includes the oscillation unit, the first multiplier, the modulation unit, the phase shift unit, the second multiplier, and the output unit. Since the oscillation unit generates the original carrier signal, which has one-over-the-predetermined-integer of the frequency of the carrier signal, it is easy to separate the carrier signal and the original carrier signal. Also, the proximity together with the original carrier signal can be removed. The original carrier signal can be removed easily using a band elimination filter. The first multiplier multiplies the frequency of the original carrier signal generated by the oscillation unit by the predetermined integer to generate the carrier signal. The modulation unit modulates the carrier signal output from the first multiplier to generate the transmission signal having the lower level than the carrier signal. However, local leak caused by leakage of the carrier signal cannot be avoided. The phase shift unit shifts the phase of the original transmission signal generated by the oscillation unit. The second multiplier multiplies the frequency of the original carrier signal, which is subject to the phase shift by the phase shift unit, by the predetermined integer to generate the cancel signal. Since the phase shift unit shifts the phase of the original carrier signal before the second multiplication unit multiplies the carrier signal, the phase shift unit shifts the phase at a low frequency as compared with the carrier signal and, therefore, can be shift the phase easily in a large amount. The output unit combines the transmission signal generated by the modulation unit with the cancel signal generated by the second multiplier to generate and output the combined signal. Thus, the first and second multipliers can provide isolation between the modulation unit and the output unit, which process the carrier signal after the multiplication, and a part that processes the original carrier signal before the multiplication. Thus, the return amount caused by leakage of high frequency and reflection can be decreased.

According to one embodiment of the invention, the output unit may include a level detection unit and a comparator. The level detection unit detects a level of the combined signal generated. The comparator compares the detected level of the combined signal with a reference level. The phase shift unit adjusts a phase shift amount for the original transmission signal in response to a comparison result by the comparator so that the detected level of the combined signal does not exceed the reference level.

With this configuration, the shift amount can be adjusted more easily than a case where a phase shift is applied to the carrier signal. The phase shift may be performed so that the cancel signal has an opposite phase to a component of the carrier signal contained in the transmission signal. Also, the reference level may be set in advance to be a level of the transmission signal without the carrier signal.

According to one embodiment of the invention, the cancel circuit may further include a level adjustor disposed between the phase shift unit and the output unit. The output unit may include a level detection unit and a comparator. The level detection unit detects a level of the combined signal generated. The comparator compares the detected level of the combined signal with a reference level. The level adjustor adjusts a level of the cancel signal in response to a comparison result by the comparator so that the detected level of the combined signal does not exceed the reference level.

If the cancel signal has an opposite phase and an equivalent level to the component of the carrier signal contained in the transmission signal, the attenuation amount of the component of the carrier signal most increases. Thus, the level adjustor adjusts the level of the cancel signal to increase the attenuation amount of the component of the carrier signal.

According to one embodiment of the invention, the cancel circuit may further include a level adjustor disposed between the phase shift unit and the output unit. The output unit includes a level detection unit and a comparator. The level detection unit detects a level of the combined signal generated. The comparator compares the detected level of the combined signal with a reference level. The phase shift unit adjusts a phase shift amount for the original transmission signal in response to a comparison result by the comparator so that the detected level of the combined signal does not exceed the reference level. The level adjustor adjusts a level of the cancel signal in response to a comparison result by the comparator so that the detected level of the combined signal does not exceed the reference level.

If the cancel signal has an opposite phase and an equivalent level to the component of the carrier signal contained in the transmission signal, the attenuation amount of the component of the carrier signal most increases. Thus, the level adjustor adjusts the level of the cancel signal to increase the attenuation amount of the component of the carrier signal. With the above-described configuration, the shift amount can be adjusted more easily than a case where a phase shift is applied to the carrier signal. The phase shift may be performed so that the cancel signal has an opposite phase to a component of the carrier signal contained in the transmission signal. Since the level and phase of the cancel signal is adjusted appropriately, it is possible to remove the component of the carrier signal leaking into the transmission signal as the local leak sufficiently.

According to one embodiment of the invention, a radar may use any cancel circuit for high frequency band local leak described above.

In this radar, the leakage of the component of the carrier signal caused by local leak can be decreased for using the radar effectively.

According to one embodiment of the invention, a digital radio communication apparatus may use any cancel circuit for high frequency band local leak described above.

In this digital radio communication apparatus, the leakage of the carrier signal component caused by local leak can be decreased for conducting digital radio communications.

### BRIEF DESCRIPTION OF THE DRAWINGS

FIG. 1 is a block diagram to show the schematic electric configuration of a cancel circuit for high frequency band local leak 10 of a first embodiment of the invention.

FIGS. 2A to 2C are schematic frequency spectrum drawings to show the operation principle of the cancel circuit for high frequency band local leak 10 of the first embodiment of the invention.

FIGS. 3A and 3B are graphs to show frequency spectrum comparison between the case where the cancel circuit for high frequency band local leak 10 of the first embodiment of the invention is not used (FIG. 3A) and the case where the cancel circuit 10 is used (FIG. 3B) to execute SS modulation in a 24-GHz band.

FIG. 4 is a block diagram to show the schematic electric configuration of a cancel circuit for high frequency band local leak 30 of a second embodiment of the invention.

FIG. 5 is a block diagram to show the schematic electric configuration of a cancel circuit for high frequency band local leak 40 of a third embodiment of the invention.

FIG. 6 is a block diagram to show the schematic electric configuration of a cancel circuit for high frequency band local leak 50 of a fourth embodiment of the invention.

FIGS. 7A and 7B are a block diagram to show the schematic electric configuration of a high frequency transmission unit adopting PSK modulation in a related art and a schematic frequency spectrum drawing of PSK modulation output.

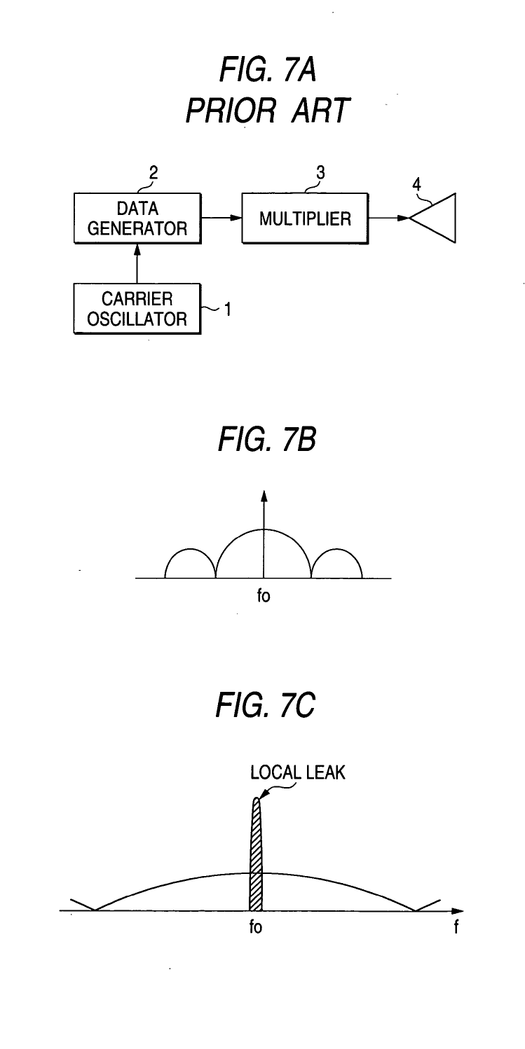

FIGS. 8A to 8C are a block diagram to show the schematic electric configuration of a high frequency transmission unit adopting representative countermeasures against local leak in a related art and schematic frequency spectrum drawing of modulation output.

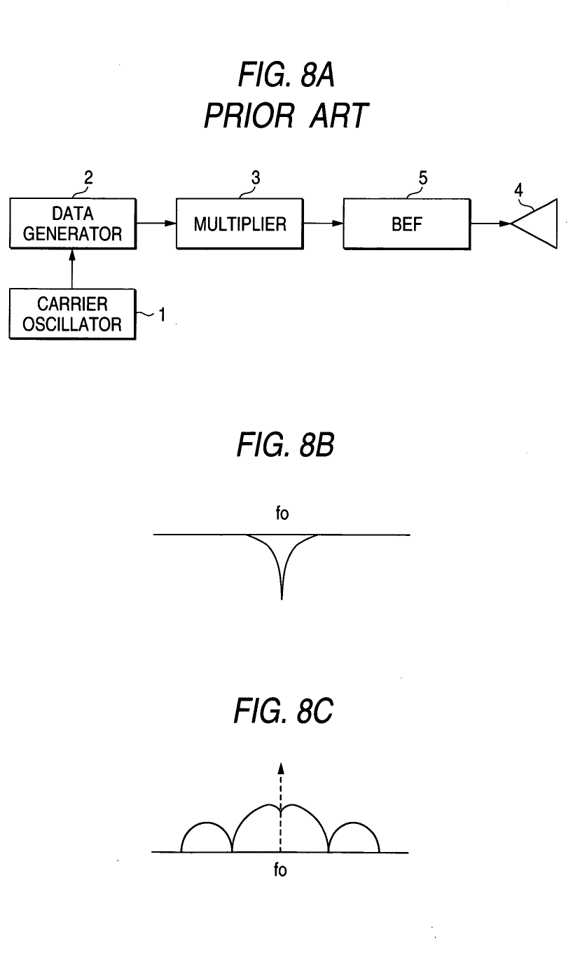

FIGS. 9A and 9B are a frequency spectrum drawing of a modulation signal occurring as the countermeasures in FIG. 8 are adopted and a waveform chart to show loss of signal.

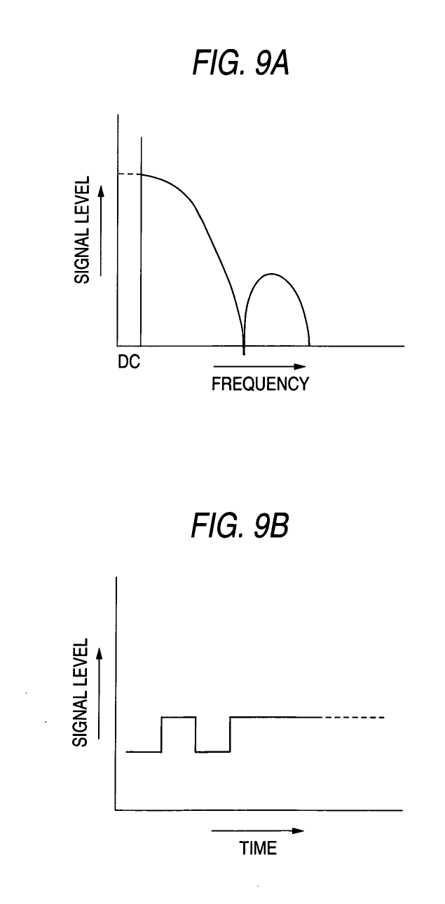

### DETAILED DESCRIPTION OF THE PREFERRED EMBODIMENT

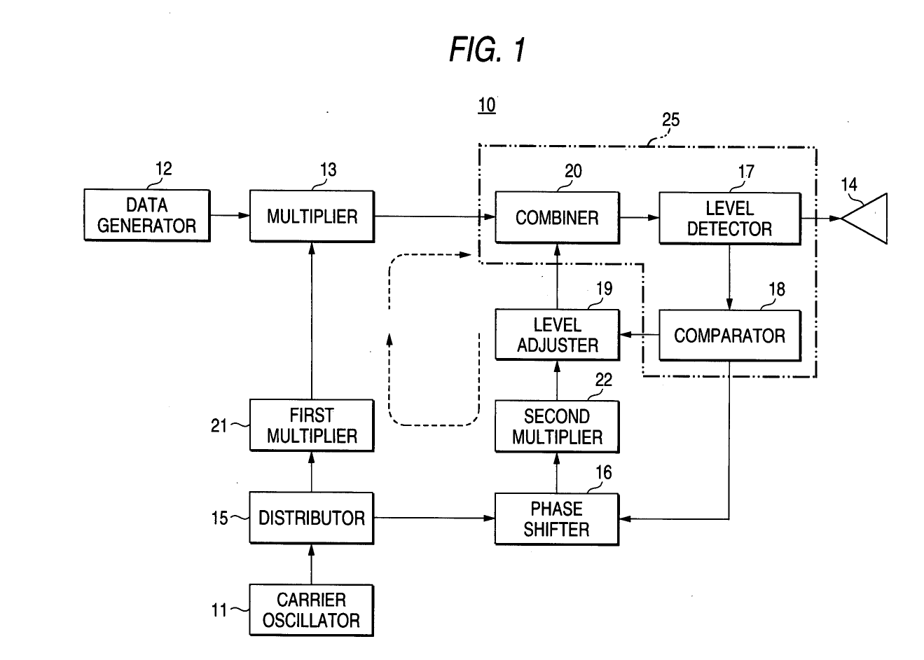

FIG. 1 shows the schematic electric configuration of a cancel circuit 10 for high frequency band local leak according to a first embodiment of the invention. In this embodiment, the high frequency means a frequency in a range of 4 GHz to 6 Hz, but this invention is not limited thereto. In modulating and transmitting a carrier signal in a high frequency band based on an oscillation signal provided from a carrier oscillator 11, the cancel circuit 10 for high frequency band local leak prevents leakage of a signal from the carrier oscillator 11. The carrier oscillator 11 generates an original carrier signal having a frequency that is the product of a predetermined one-over-an-integer, such as one-half or one-third, by frequency fo of the carrier signal. The frequency fo of the carrier signal is of a high frequency band such as microwave and millimeter wave and is, for example, several 10 GHz. A data generator 12 generates data to modulate the carrier signal of the frequency fo, and SS modulation is executed in multiplication processing in a multiplier 13. Output of SS-modulated high frequency transmission signal is transmitted from an antenna 14.

To remove the component of the carrier signal contained in the high frequency transmission signal, a distributor 15 divides the original carrier signal output from the carrier oscillator 11 into a signal for modulation in the multiplier 13 and a signal for canceling the carrier signal component after modulation. The original carrier signal for canceling is subjected to phase shift in a phase shifter 16. The phase shift amount of the phase shifter 16 can be adjusted in response to the level of the high frequency transmission signal detected by a level detector 17. A comparator 18 compares the level of the high frequency transmission signal detected by the level detector 17 with a reference level. The phase shifter 16 adjusts the phase shift amount in response to a signal indicating the comparison result output from the comparator 18. The component of the carrier signal is canceled completely when the phase is an opposite phase (a phase difference between the signals is 180 degrees) and the signal levels are equal. The signal indicating the comparison result output from the comparator 18 is also given to a level adjuster 19 and the level of the opposite phase component can be adjusted.

A combiner 20 combines the high frequency transmission signal modulated by the multiplier 13 with the carrier signal of the opposite phase whose level is adjusted by the level adjuster 19 to cancel the component of the carrier signal. A first multiplier 21 and a second multiplier 22 are provided for generating the carrier signal from the original carrier signal. The first multiplier 21 and the second multiplier 22 multiply the original carrier signal having a frequency, which is the product of one-over-an-integral by the frequency fo of the carrier signal, by the corresponding integer. For example, if the frequency of the original carrier signal is one-half or one-third of the frequency fo of the carrier signal, the first multiplier 21 and the second multiplier 22 multiply the frequency of the original carrier signal by two or three to obtain the carrier signal of the frequency fo.

Since the first multiplier 21 and the second multiplier 22 are provided, isolation can be ensured between the frequency fo of the carrier signal and the frequency of the original carrier signal. If the isolation is not ensured, the return amount caused by leakage of high frequency and reflection increases and the local leak amount increases, as indicated by a dashed line in FIG. 1. The ensuring of the isolation decreases the local leak amount.

The first multiplier 21 multiplies the original carrier signal for modulation divided by the distributor 15. The multiplier 13 modulates in the SS system the carrier signal provided from the first multiplier 21. In the modulation of the SS system, the high frequency transmission signal is generated with the level of the carrier signal decreased, but leakage of the component of the carrier signal cannot be avoided. The second multiplier 22 multiplies the original carrier signal, whose phase is shifted by the phase shifter 16, by an integer to generate a signal of the frequency fo of the carrier signal. This signal of the frequency fo may have a component of opposite phase to the carrier signal contained in the high frequency transmission signal modulated by the multiplier 13. For example, it is assumed that the first and second multipliers 21 and 22 multiply a frequency of an input signal by N (integer) and that the phase shifter 16 shifts a phase of an input signal by ΔΦ. In this case, a phase difference between the carrier signal generated by the first multiplier 21 and the signal generated by the second multiplier 22 is N×ΔΦ. It is noted that generally when a multiplier multiplies a frequency of a signal by N, the multiplier simultaneously multiplies a phase difference by N. Therefore, in this embodiment, the phase shifter 16 is required less phase shift amount than a case where the phase shifter 16 directly phase-shifts the signal after multiplied by the second multiplier 22 (that is, the signal having a higher frequency than the original carrier signal).

The combiner 20 combines the high frequency transmission signal provided from the multiplier 13 with the carrier signal of the component of opposite phase output from the second multiplier 22 to attenuate the component of the carrier signal contained in the high frequency transmission signal and output the combined signal. An output section 25 includes the combiner 20, the level detector 17, and the comparator 18.

That is, the output section 25 includes the level detector 17, which detects the level of the high frequency transmission signal after combined with the carrier signal, and the comparator 18, which compares the level of the high frequency transmission signal detected by the level detector 17 with the reference level preset as the output level of the high frequency transmission signal containing no carrier signal. The phase shifter 16 is responsive to the comparison result of the comparator 18 to adjust the phase shift amount for the original carrier signal so that the level of the high frequency transmission signal detected by the level detector 17 does not exceed the reference level. The level adjuster 19 is disposed between the phase shifter 16 and the output section 25. The level adjuster 19 is responsive to the comparison result of the comparator 18 to adjust the level of the carrier signal of the component of opposite phase to be combined by the combiner 20 so that the level of the high frequency transmission signal detected by the level detector 17 does not exceed the reference level.

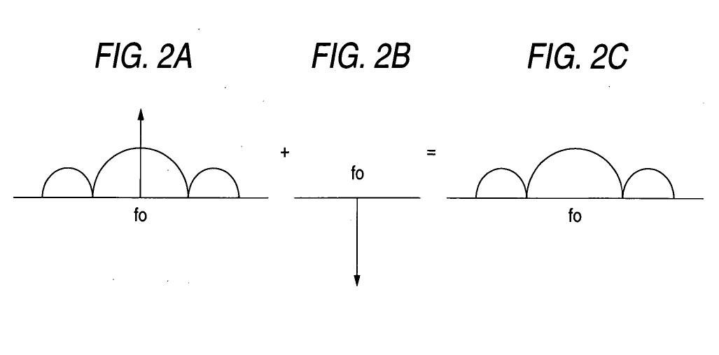

FIGS. 2A to 2C show the schematic operation principle of the cancel circuit 10 for high frequency band local leak in FIG. 1. FIG. 2A shows the frequency spectrum of the high frequency transmission signal output from the multiplier 13. The frequency spectrum spreads with the frequency fo of the carrier signal as the center and contains the component of the carrier signal caused by local leak at a large level. FIG. 2B shows the signal of opposite phase, which is output from the level adjuster 19 and will be combined by the combiner 20 with the component of the carrier signal caused by local leak to cancel the local leak. FIG. 2C shows the frequency spectrum of the high frequency transmission signal output from the combiner 20. The carrier signal component of the frequency fo has the local leak canceled and decreased to be less than the reference level.

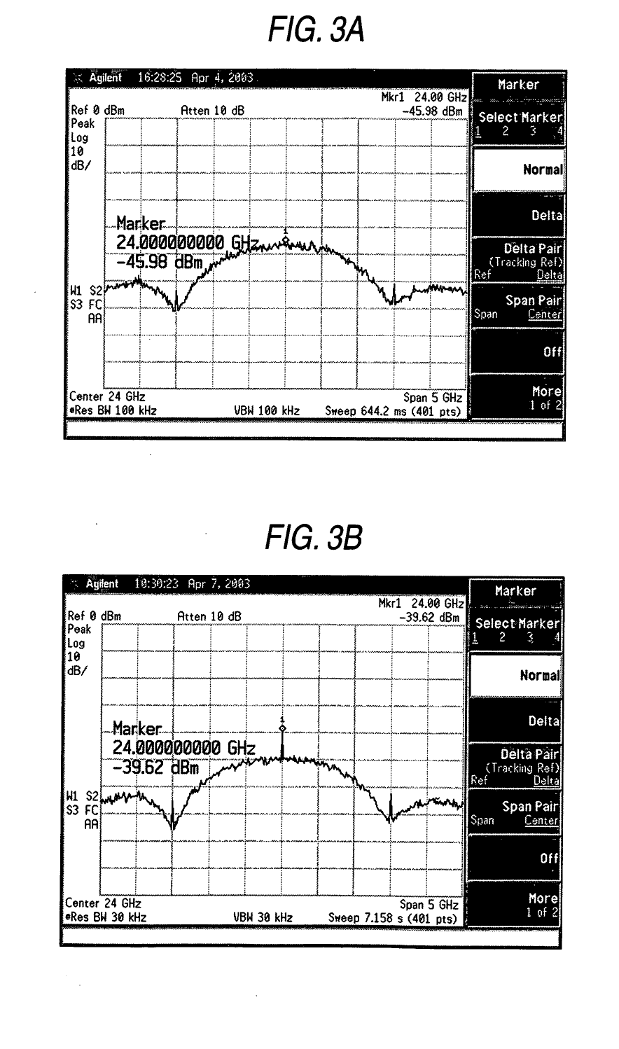

FIGS. 3A and 3B show comparison in frequency spectrum between a case where the cancel circuit 10 for high frequency band local leak in FIG. 1 is used (FIG. 3A) and a case where the cancel circuit 10 is not used (FIG. 3B) when executing SS modulation in a 24 GHz band. If the cancel circuit 10 for high frequency band local leak in FIG. 1 is not used as shown in FIG. 3B, the level of the carrier signal component becomes high; however, the carrier signal component does not appear over the frequency spectrum in FIG. 3B.

In the embodiment, the level detector 17 detects the level of the high frequency transmission signal combined with the carrier signal by the combiner 20. The comparator 18 compares the detected level of the high frequency transmission signal with the reference level. The output level of the high frequency transmission signal containing no carrier signal is preset as the reference level. Placed between the phase shifter 16 and the output section 25 is the level adjuster 19, which is responsive to the comparison result of the comparator 18 to adjust the level of the carrier signal of the component of opposite phase to be combined by the combiner 20 of the output section 25 so that the level of the high frequency transmission signal detected by the level detector 17 does not exceed the reference level. When the component of opposite phase is at equal level, the cancellation of the carrier signal component most increases the attenuation amount. Thus, the level of the component of opposite phase can be adjusted to increase the attenuation amount of the carrier signal. The phase shifter 16 is responsive to the comparison result of the comparator 18 to adjust the phase shift amount for the original carrier signal, which has lower frequency than the carrier signal, so that the level of the high frequency transmission signal detected by the level detector 17 does not exceed the reference level. Thus, the shift amount can be adjusted more easily than a case where the phase is shifted in the carrier signal and adjustment can be made to a phase, which is an opposite phase to the carrier signal to cancel the carrier signal. The phase and the level of the component for canceling the component of the carrier signal can be adjusted appropriately to sufficiently remove the carrier signal component, which leaks into the high frequency transmission signal as the local leak.

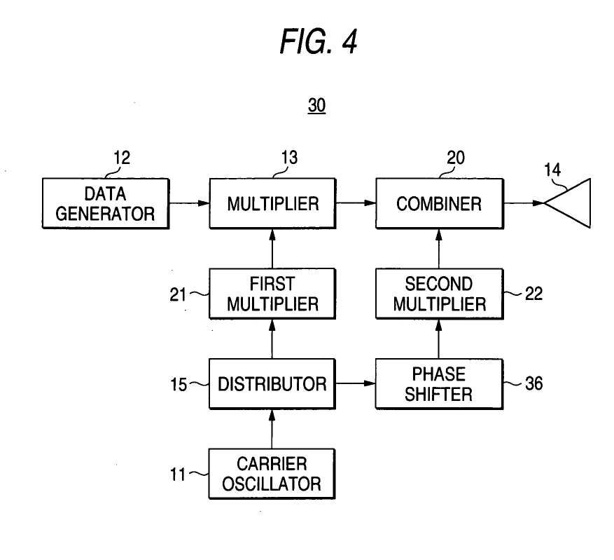

FIG. 4 shows the schematic electric configuration of a cancel circuit 30 for high frequency band local leak according to a second embodiment of the invention. Parts identical with or similar to those previously described with reference to FIG. 1 are denoted by the same reference numerals in FIG. 4 and will not be discussed again. In the second embodiment, a phase shifter 36 executes given phase shift. The component combined by a combiner 20 to cancel the component of a carrier signal need not necessarily be of precisely opposite phase of 180 degrees so long as the level of the carrier signal component is lower than that of a SS-modulated high frequency transmission signal. If the phase shift amount of the phase shifter 36 is set appropriately, local leak can be decreased without performing feedback control as in FIG. 1 and the configuration can be simplified and the cost can be reduced.

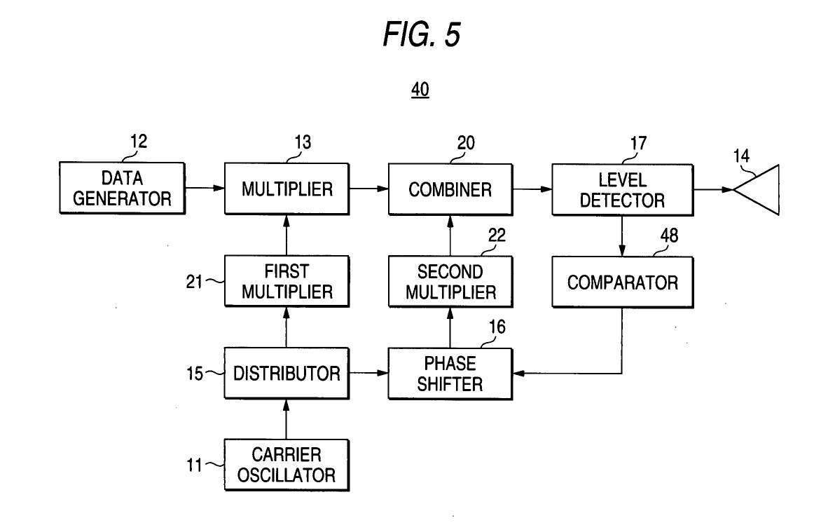

FIG. 5 shows the schematic electric configuration of a cancel circuit 40 for high frequency band local leak according to a third embodiment of the invention. Parts identical with or similar to those previously described with reference to FIG. 1 or FIG. 4 are denoted by the same reference numerals in FIG. 5 and will not be discussed again. In the third embodiment, a comparator 48 adjusts the phase shift amount in a phase shifter 16. Since feedback control of the phase shift amount is performed, the decrease effect of local leak can be enhanced as compared with the first embodiment in FIG. 3.

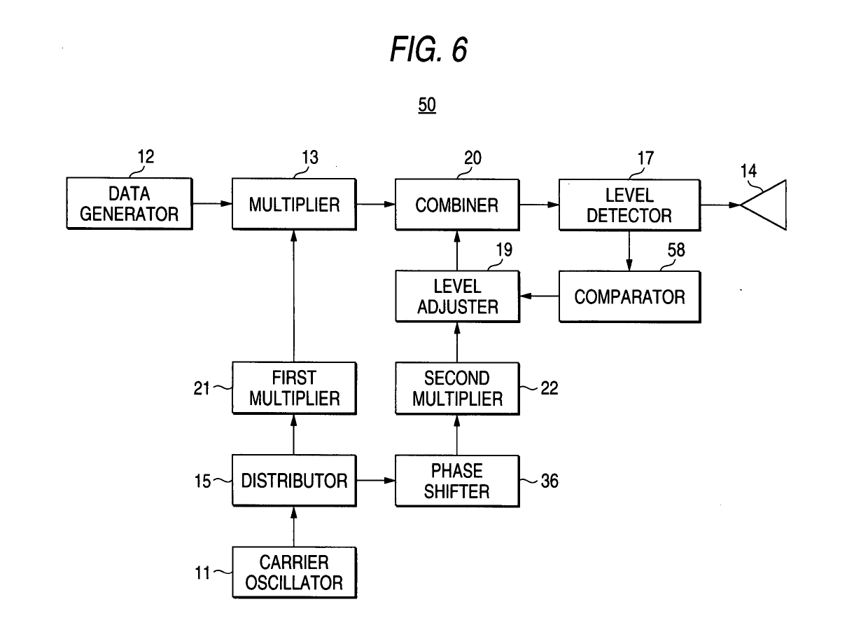

FIG. 6 shows the schematic electric configuration of a cancel circuit 50 for high frequency band local leak according to a fourth embodiment of the invention. Parts identical with or similar to those previously described with reference to FIG. 1, FIG. 4, or FIG. 5 are denoted by the same reference numerals in FIG. 6 and will not be discussed again. In the fourth embodiment, a comparator 58 controls the level adjustment amount of a level adjuster 19. Since feedback control of the level of opposite phase component is performed, the decrease effect of local leak can be enhanced as compared with the first embodiment in FIG. 3.

In the embodiments described above, the multiplier 13 executes SS modulation to spread the frequency component to a wide band. Since the leakage of the carrier signal component caused by local leak is decreased, the feature of the SS system that the SS system can use a pulse signal of extremely short duration such as 1 nanosecond can be used effectively.

The local leak cancel circuit can be applied to a radar. A spread spectrum signal is transmitted to a target from a transmitter having the local leak cancel circuit installed in a radar. Then, a receiver installed in the radar inversely spreads the reflection signal from the target and can detect a distance to the target on the basis of the inversely spread signal. The obtained distance has good accuracy because of no local-leak. Furthermore, the local leak cancel circuit may be installed in a digital radio communication apparatus for transmitting a transmission signal to the outside for conducting communications.

As described above, according to the embodiments of the invention, the carrier oscillator 11 generates an original carrier signal having a frequency that is the product of a predetermined one-over-an-integer by frequency fo of the carrier signal, so that the proximity together with the original carrier signal can be removed using a band elimination filter, etc. Since the phase shifter 16, 36 phase-shifts the original carrier signal before the second multiplier 22 multiplies, the phase shifter 16, 36 is required to perform the phase shift at a lower frequency than the carrier signal and can shift the phase by a large amount easily. Also, the first and second multipliers 21, 22 provides isolation between the multiplier 13 and the output section 25, which process the carrier signal after the multiplication, and a part that processes the original carrier signal before the multiplication. Thus, the return amount caused by leakage of high frequency and reflection can be decreased.

The phase shifter 16 adjusts a phase shift amount for the original transmission signal, which has a lower frequency than the carrier signal, so that the detected level of the high frequency transmission signal does not exceed the reference level. Thus, in comparison with a case of shifting a phase of the carrier signal, the phase shift amount can be adjusted easily. The phase shifter 16 may shift the phase of the original carrier signal so that a signal generated by the second multiplier 22 has an opposite phase to the carrier signal.

The level adjustor 19 may be disposed between the phase shifter 16 and the output section 25. The level adjustor 19 adjusts a level of the signal provided from the second multiplier 22 so that the detected level of the high frequency transmission signal does not exceed the reference level. Thus, the attenuation amount of the component of the carrier signal contained in the transmission signal can be increased.

As shown in FIG. 1, the cancel circuit 10 includes the phase shifter 16 and the level adjustor 19. When the signal provided from the level adjustor 19 has an opposite phase and an equivalent level to the component of the carrier signal contained in the transmission signal, the attenuation amount becomes the highest. Thus, the level adjustor 19 disposed between the phase shifter 16 and the output section 25 adjusts the level of the signal provided from the second multiplier 22 in order to increase the attenuation amount of the carrier signal.

According to the invention, a target can be detected with good accuracy by a radar effectively using the feature of the SS system to spread the frequency component to a wide band, for example.

According to the invention, digital radio communications can be conducted without local leak.

What is claimed is:

1. A cancel circuit for local leak, comprising:
an oscillation unit that generates an original carrier signal, which has one-over-a-predetermined-integer of a frequency of a carrier signal;
a first multiplier that multiplies a frequency of the original carrier signal generated by the oscillation unit by the integer to generate the carrier signal;
a modulation unit that modulates the carrier signal output from the first multiplier to generate a transmission signal having a lower level than the carrier signal;
a phase shift unit that shifts a phase of the original transmission signal generated by the oscillation unit;
a second multiplier that multiplies a frequency of the original carrier signal, which is subject to the phase shift by the phase shift unit, by the integer to generate a cancel signal; and
an output unit that combines the transmission signal generated by the modulation unit with the cancel signal generated by the second multiplier to generate and output a combined signal.

2. The cancel circuit according to claim 1, wherein the cancel signal has an opposite phase to a component of the carrier signal contained in the transmission signal generated by the modulation unit.

3. The cancel circuit according to claim 1, wherein the output unit that combines the transmission signal generated by the modulation unit with the cancel signal generated by the second multiplier to attenuate a component of the carrier signal contained in the transmission signal generated by the modulation unit.

4. The cancel circuit according to claim 1, wherein the transmission signal has a frequency in a range of 4 GHz to 6 GHz.

5. The cancel circuit according to claim 1, wherein:
the output unit includes:
a level detection unit that detects a level of the combined signal generated; and
a comparator that compares the detected level of the combined signal with a reference level; and
the phase shift unit adjusts a phase shift amount for the original transmission signal in response to a comparison result by the comparator so that the detected level of the combined signal does not exceed the reference level.

6. The cancel circuit according to claim 5, wherein the reference level is set in advance to be a level of the transmission signal without the carrier signal.

7. The cancel circuit according to claim 1, further comprising:
a level adjustor disposed between the phase shift unit and the output unit, wherein:
the output unit includes:
a level detection unit that detects a level of the combined signal generated; and
a comparator that compares the detected level of the combined signal with a reference level; and
the level adjustor adjusts a level of the cancel signal in response to a comparison result by the comparator so that the detected level of the combined signal does not exceed the reference level.

8. The cancel circuit according to claim 7, wherein the reference level is set in advance to be a level of the transmission signal without the carrier signal.

9. The cancel circuit according to claim 1, further comprising:
a level adjustor disposed between the phase shift unit and the output unit, wherein:
the output unit includes:
a level detection unit that detects a level of the combined signal generated; and
a comparator that compares the detected level of the combined signal with a reference level;
the phase shift unit adjusts a phase shift amount for the original transmission signal in response to a comparison result by the comparator so that the detected level of the combined signal does not exceed the reference level; and
the level adjustor adjusts a level of the cancel signal in response to a comparison result by the comparator so that the detected level of the combined signal does not exceed the reference level.

10. The cancel circuit according to claim 9, wherein the reference level is set in advance to be a level of the transmission signal without the carrier signal.

11. A radar comprising:
a cancel circuit for local leak including:
an oscillation unit that generates an original carrier signal, which has one-over-a-predetermined-integer of a frequency of a carrier signal;
a first multiplier that multiplies a frequency of the original carrier signal generated by the oscillation unit by the integer to generate the carrier signal and outputs the carrier signal;
a modulation unit that modulates the carrier signal output from the first multiplier to generate a transmission signal having a lower level than the carrier signal;
a phase shift unit that shifts a phase of the original transmission signal generated by the oscillation unit;
a second multiplier that multiplies a frequency of the original carrier signal, which is subject to the phase shift by the phase shift unit, by the integer to generate a cancel signal; and
an output unit that combines the transmission signal generated by the modulation unit with the cancel signal generated by the second multiplier to generate a combined signal.

12. A digital radio communication apparatus comprising:
a cancel circuit for local leak including:
an oscillation unit that generates an original carrier signal, which has one-over-a-predetermined-integer of a frequency of a carrier signal;
a first multiplier that multiplies a frequency of the original carrier signal generated by the oscillation unit by the integer to generate the carrier signal and outputs the carrier signal;
a modulation unit that modulates the carrier signal output from the first multiplier to generate a transmission signal having a lower level than the carrier signal;
a phase shift unit that shifts a phase of the original transmission signal generated by the oscillation unit;
a second multiplier that multiplies a frequency of the original carrier signal, which is subject to the phase shift by the phase shift unit, by the integer to generate a cancel signal; and
an output unit that combines the transmission signal generated by the modulation unit with the cancel signal generated by the second multiplier to generate a combined signal.
